(19) United States
(12) Patent Application Publication
(10) Pub. No.: US 2012/0277131 A1
(43) Pub. Date: Nov. 1, 2012

(54) SLIDING MEMBER

(75) Inventors: Hiroyuki Asakura, Inuyama (JP); Satoshi Takayanagi, Inuyama (JP); Mikihito Yasui, Inuyama (JP)

(73) Assignee: DAIDO METAL COMPANY LTD, AICHI (JP)

(21) Appl. No.: 13/520,661

(22) PCT Filed: Feb. 4, 2011
(86) PCT No.: PCT/JP2011/052397

§ 371 Date: Jul. 5, 2012

(30) Foreign Application Priority Data
Feb. 5, 2010 (JP) 2010-024199

(51) Int. Cl. F16C 33/12

(52) U.S. Cl. 508/103

(57) ABSTRACT

Disclosed is a sliding member having an overlay layer (13) containing Bi-based particles (14) comprising Bi or a Bi alloy. The long axis of the Bi-based particles (14) is considered to be X, the short axis Y, and the aspect ratio Z=X÷Y. The aforementioned Bi-based particles are classified as one of either first Bi-based particles that satisfy Z<2, second Bi-based particles that satisfy 2≦Z<3, or third Bi-based particles that satisfy 3≦Z. With respect to the total number of Bi-based particles, considering the proportion that are first Bi-based particles to be a%, the proportion that are second Bi-based particles to be b%, the proportion that are third Bi-based particles to be c%, a÷b=d, and a÷c=e, the sliding member satisfies: a≧30, 0.5≦d≦6.0, and 0.5≦e≦6.0.

### TECHNICAL FIELD

The present invention relates to a sliding member having an overlay layer including Bi-based particles consisting of Bi or a Bi alloy.

### BACKGROUND ART

Among sliding members, a sliding bearing used in an internal-combustion engine for automobiles or the like has a base composed of a back metal layer made of e.g. a steel, and a bearing alloy layer made of a Cu alloy or an Al alloy on the back metal layer. Generally, an overlay layer is provided on the base in order to improve bearing properties, such as fatigue resistance or seizure resistance.

The overlay layer has been conventionally made of a soft Pb alloy. In recent years, it has been proposed to use Bi as an alternate material of Pb, since Pb has a large environmental burden. Bi has a problem that a sliding bearing having an overlay layer made of Bi has in general inferior fatigue resistance and seizure resistance in comparison with those made of a Pb alloy, since Bi is brittle in nature.

For this reason, for example Patent Literature 1 discloses Bi or a Bi alloy forming an overlay layer has columnar grains. The columnar grains in Patent Literature 1 refer to crystal structures growing substantially vertically from a surface of the base, in other words, crystal grains which are long in a thickness direction of the overlay layer. According to Patent Literature 1, a load of a shaft which is a sliding mate of a crankshaft and the like is supported by the grains of Bi or a Bi alloy oriented in a longitudinal direction, whereby an improvement in the fatigue resistance of the overlay layer is achieved. Furthermore, according to Patent Literature 1, a dense concave-convex surface is formed on the sliding surface of the overlay layer by projections on a sliding surface side of the Bi grains, whereby a lubricant is held in the concavities of the sliding surface to improve seizure resistance of the overlay layer.

### CITATION LIST

### Patent Literature

Patent Literature 1: JP-A-2006-266445

### SUMMARY OF THE INVENTION

In a field of recent internal-combustion engines, a wall thickness of a connecting rod is reduced for saving weight in order to improve fuel consumption. Since the wall thickness of the connecting rod is reduced, the connecting rod is liable to be deformed due to a decrease in the rigidity of the connecting rod. Thus, a sliding bearing in the connecting rod is also liable to be deformed, and fatigue occurs in the sliding bearing due to repetitions of the deformation.

Furthermore, if a lubricant oil having low viscosity is used to improve fuel consumption, an oil film of the lubricant oil is liable to be broken due to a load from a mating shaft. Thus, a problem arises that the mating shaft comes into contact with a sliding surface of the sliding bearing without the lubricating oil therebetween, thereby seizure may occur.

Therefore, a sliding member having improved fatigue resistance and seizure resistance in comparison with the conventional ones is demanded.

The invention was made under the above circumstances. An object of the invention is to provide a sliding member having an overlay layer including Bi-based particles consisting of Bi or a Bi alloy and being excellent in fatigue resistance and seizure resistance.

The inventors noted a shape of Bi-based particles in an overlay layer containing Bi-based particles consisting of Bi or a Bi alloy, and devoted themselves to experiments. As a result, the inventors obtained a recognition that a sliding member having improved fatigue and seizure resistance is obtained when a ratio of three types of Bi-based particles is in a certain range, where the Bi-based particles in the overlay layer are classified by shape into the three types.

On the basis of the recognition, the inventors have made the following invention.

The sliding member of the invention has a base, and an overlay layer on the base and containing Bi-based particles consisting of Bi or a Bi alloy. In a cross section of the overlay layer along a thickness direction, a major axis of the Bi-based particles has a length expressed by X, and a minor axis orthogonal to the major axis X at a position of a midpoint of the major axis has a length expressed by Y. An aspect ratio Z is defined by X/Y. The Bi-based particles are classified into any one of first Bi-based particles satisfying Z<2, second Bi-based particles satisfying 2≦Z<3, and third Bi-based particles satisfying 3≦Z. A ratio of a number of the first Bi-based particles in relation to a total number of the Bi-based particles is expressed by a%, a ratio of a number of the second Bi-based particles is expressed by b%, a ratio of a number of the third Bi-based particles is expressed by c%, a/b is expressed by d and a/c is expressed by e. Then, the sliding member of the invention satisfies the following formula: a≧30; 0.5≦d≦6.0; and 0.5≦e≦6.0.

The “base” referred to in the specification indicates a portion supporting the overlay layer, as a part of the sliding member. For example, in a case where a bearing alloy layer is formed on a back metal layer and an intermediate layer as a bonding layer is interposed between the bearing alloy layer and the overlay layer, the base includes the back metal layer, the bearing alloy layer and the intermediate layer. Furthermore, in a case where a bearing alloy layer is formed on a back metal layer and an overlay layer is provided on the bearing alloy layer, the base includes the back metal layer and the bearing alloy layer. In addition, in a case where an overlay layer is provided directly on a back metal layer, the base includes the back metal layer.

The bearing alloy layer is formed of an Al-based bearing alloy, a Cu-based bearing alloy, or other metals. Bi-based particles are included in the overlay layer. The Bi-based particles are grains consisting of Bi or a Bi alloy. The Bi alloy includes e.g. a Bi—Cu alloy, a Bi—Sn alloy, or a Bi—Sn—Cu alloy.

The back metal layer, the bearing alloy layer, the intermediate layer, and the overlay layer may contain other elements other than the above. They may contain inevitable impurities.

An observation of a cross section of the overlay layer is performed with use of a transmission electron microscope, a scanning electron microscope, an FIB/SIM (focus ion beam/scanning ion microscope), EBSP (electron backscatter diffraction analysis image process) or other means which enables grains to be observed. An observed field of view is 5 μm×5 μm, and a measurement magnification in the case is preferably 25,000 times.

A shape and size of the Bi-based particles in a cross section cutting the overlay layer in a thickness direction will be described here. The “thickness direction” referred to in this specification indicates a direction perpendicular to a surface of the base when a surface on the overlay layer side is regarded as a horizontal surface. According to the invention, the Bi-based particles in the overlay layer were classified by shape into three types.

Specifically, when a length of a major axis of the Bi-based particles in the overlay layer is expressed by X, a length of a minor axis is expressed by Y, and X/Y is determined to be an aspect ratio Z as shown in FIG. 1, the Bi-based particles are classified into any one of first Bi-based particles satisfying Z<2, second Bi-based particles satisfying 2≦Z<3, and third Bi-based particles satisfying 3≦Z.

As shown in FIG. 2, the major axis X indicates a straight line drawn so that a maximum length in a Bi-based particle is obtained. The minor axis Y is a straight line drawn so as to be orthogonal to the major axis X at a midpoint of the major axis. The major axis X and the minor axis Y are obtained by observing a cross section of the overlay layer under the electron microscopes or the like and actually measuring a size of the Bi-based particle.

“Aspect ratio” referred to in the specification indicates a value obtained by dividing the major axis length X by the minor axis length Y as described above. For example, when a particle is spherical, the major axis X and the minor axis Y have the same length, and the aspect ratio Z becomes 1. When the Bi-based particles are classified into three shapes as described above according to the invention, the first Bi-based particles have a shape closest to a sphere.

According to the invention, when a ratio of a number of the first Bi-based particles in relation to a total number of Bi-based particles is expressed by a%, a ratio of a number of the second Bi-based particles is expressed by b%, a ratio of a number of the third Bi-based particles is expressed by c%, and a ratio “d” is determined as rate of aspect ratio a/b and a ratio “e” is determined as a rate of aspect ratio a/c, a size of the Bi-based particles is adjusted so as to satisfy a≧b 30, 0.5≦d≦6.0, and 0.5≦e≦6.0.

The term “total number of Bi-based particles” indicates a total number of the first Bi-based particles, the second Bi-based particles, and the third Bi-based particles. The number of the Bi-based particles (the first Bi-based particles, the second Bi-based particles, and the third Bi-based particles) is obtained by observing a cross section of the overlay layer with the electron microscope or the like and actually counting the number of particles.

The ratio of the number of particles of the first Bi-based particles being “a≧30” means that the ratio of the number of particles of the first Bi-based particles in relation to the total number of the Bi-based particles is not less than 30%.

When the load from a mating member is applied to a sliding surface of the overlay layer, the load is supported by the Bi-based particles. The first Bi-based particles among the Bi-based particles are liable to be deformed downwardly and horizontally by the applied load. Thus, the sliding surface of the overlay layer is liable to be deformed in the vicinity of a portion where the load is applied. Thus, conformability of the sliding member is improved. As a result, the overlay layer of the sliding member can easily distribute the load from the mating member and it is possible to reduce affects from the mating member when it abuts locally against the overlay layer.

The rate of aspect ratio “0.5≦d≦6.0” means that the number of the first Bi-based particles is 0.5 times to 6.0 times the number of the second Bi-based particles. Since the aspect ratio Z of the second Bi-based particles is greater than that of the first Bi-based particles, the second Bi-based particles have a more elongated shape than the first Bi-based particles. In a case where the second Bi-based particles are distributed in the overlay layer, a probability that the major axis X of the second Bi-based particles is directed along the thickness direction in the overlay layer becomes higher. In this case, when the load from a mating member is applied to the sliding surface of the overlay layer, the load is easily supported by surfaces of the second Bi-based particles on the sliding surface side (hereinafter the surface on the sliding surface side is referred to as “top end surface”). Thus, when a load is applied toward the base side in the thickness direction of the base from the top end surface of the second Bi-based particles, a compressive force is applied to the second Bi-based particle in the longitudinal direction. However, due to a large longitudinal strength of the second Bi-based particle, the second Bi-based particle is difficult to be deformed in the longitudinal direction.

The rate of aspect ratio “0.5≦e≦6.0” indicates that the number of the first Bi-based particles is 0.5 times to 6.0 times the number of the third Bi-based particles. Since the aspect ratio Z of the third Bi-based particles is larger than that of the second Bi-based particles, the third Bi-based particles have more elongated shape than the second Bi-based particles. Also, the third Bi-based particles act similarly as the second Bi-based particles. In particular, since the third Bi-based particles have a more elongated shape than the second Bi-based particles, the third Bi-based particles are not liable to be deformed all the more compared to the second Bi-based particles. As the above, a sliding member has excellent fatigue resistance and seizure resistance when it has the first Bi-based particle satisfying Z<2, the second Bi-based particles satisfying 2≦Z<3, and third Bi-based particles satisfying 3≦Z, and satisfies a≧30%, 0.5≦d≦6.0, and 0.5≦e≦6.0.

According to an embodiment of the invention, the sliding member satisfies 35≦a≦70, 0.8≦d≦4.0, and 0.8≦e≦4.0.

It is possible to obtain more improved fatigue and seizure resistance when 35≦a≦70, 0.8≦d≦4.0, and 0.8≦e≦4.0.

According to an embodiment of the invention, the base includes a back metal layer, a bearing alloy layer on the back metal layer, and an intermediate layer on the bearing alloy layer, and the intermediate layer contains any one of Ni, a Ni alloy, Ag, a Ag alloy, Co, a Co alloy, Cu and a Cu alloy. For example, the Ni alloy includes e.g. a Ni—Sn alloy.

In this embodiment, an overlay layer is provided on the base including the back metal layer, the bearing alloy layer on the back metal layer, and the intermediate layer on the bearing alloy layer. Since the base includes the bearing alloy layer, the sliding member has bearing performance of the bearing alloy layer. Furthermore, since the intermediate layer is provided as a bonding layer between the bearing alloy layer and the overlay layer, it is possible to prevent the overlay layer from peeling off from the base as much as possible. The intermediate layer made of Ni or the like can be bonded strongly to the bearing alloy layer and the overlay layer. This can effectively prevent the overlay layer from peeling off from the base.

In a case where an overlay layer containing the Bi-based particles consisting of Bi or a Bi alloy is formed on a base with use of Bi electroplating, the inventors found that a shape of the Bi-based particles in the overlay layer can be varied by generating minute coarseness and fineness of current density on a surface of the base during the Bi electroplating. The inventors founds that minute coarseness and fineness of current density can be made by supplying micronanobubbles, which are minute bubbles, on the surface of the base during the Bi electroplating for forming the overlay layer on the base. Thereby, it is possible to distribute the first Bi-based particles, the second Bi-based particles, and the third Bi-based particles in the overlay layer.

A method of generating the micronanobubbles includes e.g. an ejector type, a cavitation type, a turning type, a pressure dissolution type, an ultrasonic type, or a micropore type. Preferably, the micronanobubbles have a diameter of 500 nm to 1000 nm When the diameter of the micronanobubbles is not more than 1000 nm, minute coarseness and fineness of current density tend to be formed on the surface of the base, and it is possible to easily form Bi-based particles having different shapes. Please note that the method of controlling the shape of Bi-based particles is not limited to the method described above.

In view of improving fatigue resistance, a carbon content in the overlay layer is preferably not more than 0.2 mass % and more preferably not more than 0.1 mass %. The inventors found through experiments that the overlay layer 13 tends to become brittle and the fatigue resistance of the overlay layer tends to be decreased as the carbon content increases in a case where carbon is present at the boundaries of the Bi-based particles in the overlay layer. The inventors also found through experiments that the lower the carbon content is in the overlay layer, the higher becomes a maximum specific load at which fatigue does not occur. For example, the inventors found that the maximum specific loads at which fatigue does not occur in a sliding member, whose carbon content in the overlay layer is 0.2 mass %, are 5 to 10 MPa higher than that in a sliding member whose carbon content in the overlay layer exceeds 0.2 mass %.

In general, the carbon content in the overlay layer is proportional to an amount of additives in a Bi electroplating solution. The additives are essential for improving stability of film, such as uniform electrodepositability of the overlay layer. The inventors also found that the overlay layer has excellent stability of film for the base even when the amount of the additives is reduced compared to conventional one by adopting the micronanobubble method for reducing the carbon content in the overlay layer, for example in Bi electroplating.

The inventors found through experiments that an orientation index of (012) plane in terms of Miller's index is preferably not more than 14% in the overlay layer in a sliding member having a base and an overlay layer on the base and containing Bi-based particles consisting of Bi or a Bi alloy, in view of improving the fatigue resistance of the sliding member. According to the experiments, when the orientation index of the (012) plane of the overlay layer is smaller, the maximum pressure at which fatigue does not occur increased. The orientation index is defined such that the orientation index=R (012)×100/ΣR (hkl) when X-ray diffraction intensity of each surface of a crystal of Bi or the a alloy in the overlay layer is denoted by R (hkl). In the expression, R(012) is X-ray diffraction intensity of (012) plane and ΣR (hkl) is a summation of X-ray intensity of all surface.

The overlay layer having the orientation index of (012) plane being not more than 14% is obtained, for example by supplying micronanobubbles, which are minute bubbles, to a plating solution during performing Bi electroplating and changing a feed rate thereof at constant time intervals. Specifically, the orientation index of (012) plane of the overlay layer became not more than 14% by supplying micronanobubbles to the Bi electroplating solution while verifying a feed rate from 50 mL/minute to 10 L/minute at an interval of 5 to 60 seconds.

The overlay layer having the orientation index of (012) plane being not more than 14% may also be obtained by methods other than the method involving micronanobubbles.

### BRIEF DESCRIPTION OF DRAWINGS

FIG. 1 is a cross sectional view schematically showing a sliding member according to an embodiment of the invention.

FIG. 2 is a diagram showing a major axis X and a minor axis Y of a Bi-based particle in an overlay layer.

### DESCRIPTION OF EMBODIMENTS

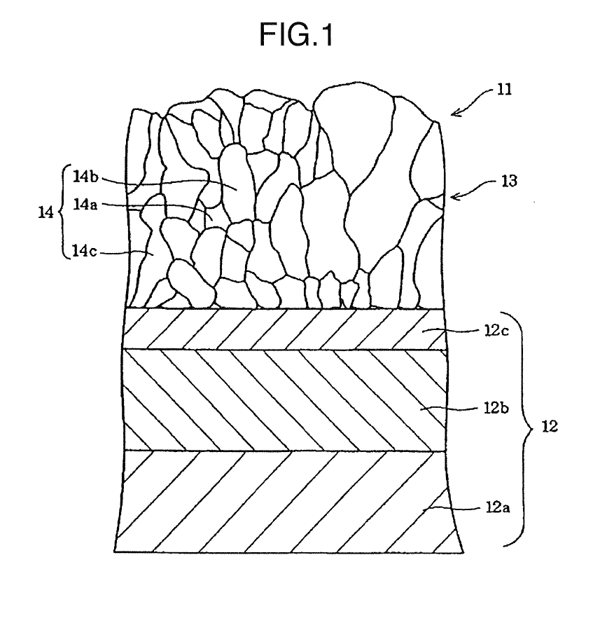

Referring to FIG. 1, an embodiment of a sliding member according to the invention will be described.

A sliding material 11 shown in FIG. 1 includes a base 12 and an overlay layer 13 on the base 12. The “base” referred to in the specification indicates a portion of the sliding member, which supports the overlay layer 13. For example, as shown in FIG. 1 where a bearing alloy layer 12b is provided on a back metal layer 12a and an intermediate layer 12c as a bonding layer is provided between the bearing alloy layer 12b and the overlay layer 13, the base 12 includes three layers of the back metal layer 12a, the bearing alloy layer 12b, and the intermediate layer 12c. Furthermore, in a case where a bearing alloy layer 12b is provided on the back metal layer 12a and an overlay layer 13 is provided on the bearing alloy layer 12b, the base 12 includes two layers of the back metal layer 12a and the bearing alloy layer 12b. In addition, in a case where an overlay layer 13 is provided directly on a back metal layer 12a, the base 12 is the back metal layer 12a.

The bearing alloy layer 12b is formed of an Al-based bearing alloy, a Cu-based bearing alloy, or other metal. Bi-based particles 14 are included in the overlay layer 13. The Bi-based particles 14 are crystal grains consisting of Bi or a Bi alloy. The Bi alloy includes such as a Bi—Cu alloy, a Bi—Sn alloy, or a Bi—Sn—Cu alloy.

The back metal layer 12a, the bearing alloy layer 12b, and the overlay layer 13 may contain elements other than the above-described elements as well as inevitable impurities.

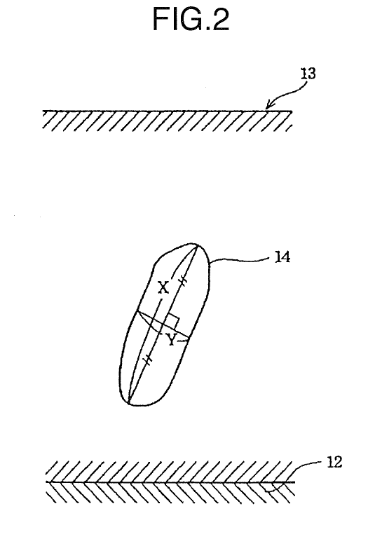

A cross section of the overlay layer 13 may be observed with use of a transmission electron microscope, a scanning electron microscope, an FIB/SIM (a focus ion beam/scanning ion microscope), EBSP (the electron backscatter diffraction analysis image process) or other means which enables crystal grains to be observed. An observational field of view is 5 μm×5 μm, and a measurement magnification in this case is preferably 25,000 times. FIG. 2 schematically shows a Bi-based particle 14 in a cross section obtained by cutting the overlay layer 13 along a thickness direction. The “thickness direction” referred to here indicates a direction perpendicular to a horizontal surface of the base 12 when a surface on the overlay layer 13 side among the surfaces of the base 12 is regarded as this horizontal surface.

According to the invention, the Bi-based particles 14 in the overlay layer 13 were classified by shape into three types.

Specifically, as shown in FIG. 2, a length of a major axis of the Bi-based particles 14 in the overlay layer 13 is denoted by X, and a length of a minor axis is denoted by Y. An aspect ratio Z is defined by X/Y. As shown in FIG. 1, the Bi-based particles were classified into any one of first Bi-based particles 14a satisfying Z<2, second Bi-based particles 14b satisfying 2≦Z<3, and third Bi-based particles 14c satisfying 3≦Z. As shown in FIG. 2, the major axis X refers to a straight line drawn such that a maximum length of a Bi-based particle 14 is obtained. The minor axis Y is a straight line drawn so as to be orthogonal to the major axis X at a midpoint of the major axis X. The major axis X and the minor axis Y are obtained by observing a cross section of the overlay layer 13 with the electron microscopes or the like and actually measuring a size of the Bi-based particle 14.

The “aspect ratio” refers to in the specification indicates a value obtained by dividing the major axis X by the minor axis Y. For example, when a particle is spherical, the major axis X and the minor axis Y have the same length, and the aspect ratio Z becomes 1. In the invention, when the Bi-based particles 14 are classified into three shapes, the first Bi-based particles 14a have a shape closest to a sphere.

In the invention, when a ratio of a number of the first Bi-based particles 14a in relation to a total number of the Bi-based particles is denoted by a%, a ratio of a number of the second Bi-based particles 14b is denoted by b%, and a ratio of the third Bi-based particles 14c is denoted by c%, a rate of aspect ratios a/b is expressed as “d” and a rate of aspect ratio a/c is expressed as “e”. A size of the Bi-based particles is adjusted so as to ensure that a≧30, 0.5≦d≦6.0, and 0.5≦e≦6.0 are satisfied.

The “total number of Bi-based particles 14” is a total of number of the first Bi-based particles 14a, the second Bi-based particles 14b, and the third Bi-based particles 14c. The number of the Bi-based particles 14 (the first Bi-based particles 14a, the second Bi-based particles 14b, and the third Bi-based particles 14c) is obtained by observing a cross section of the overlay layer 13 with the above-described electron microscopes or the like and actually counting the number of particles.

According to the invention, “a≧30” shows that a ratio of number of the first Bi-based particles 14a in relation to a total number of the Bi-based particles 14 is not less than 30%.

When a load from a mating member is applied to a sliding surface of the overlay layer 13, the load is supported by the Bi-based particles 14. The first Bi-based particles 14a among the Bi-based particles 14 are liable to be deformed downwardly and the horizontally by the applied load. Thus, the sliding surface of the overlay layer 13 is liable to be deformed in the vicinity of a load-applied portion, thereby conformability of the sliding member 11 is improved. As a result, the overlay layer 13 of the sliding member 11 can easily distribute the load received from the mating member and it is possible to reduce affects when the mating member abuts locally against the overlay layer 13.

According to the invention, “0.5≦d≦6.0” shows that a number of the first Bi-based particles 14a is 0.5 to 6.0 times the number of the second Bi-based particles 14b. Since the aspect ratio Z of the second Bi-based particles 14b is greater than that of the first Bi-based particles 14a, the second Bi-based particles 14b have a more elongated shape than the first Bi-based particles 14a. In a case where the second Bi-based particles 14a are distributed in the overlay layer 13, probability that the major axis X of the second Bi-based particles 14b extends along a thickness direction of the overlay layer 13 is also high. In the case, when a load from a mating member is applied to the sliding surface of the overlay layer 13, the load tends to be easily supported by a surfaces of the second Bi-based particles 14b on the sliding surface side (hereinafter the surface on the sliding surface side is referred to as “top end surface”). Thus, when the load is applied toward the base 12 side in the thickness direction of the base 12 from the top end surface of the second Bi-based particles 14b, a compressive force is applied to the second Bi-based particle 14b in a longitudinal direction. However, due to a high strength in the longitudinal direction of the second Bi-based particle 14b, the second Bi-based particle 14b is difficult to be deformed in the longitudinal direction.

According to the invention, “0.5≦e≦6.0” shows that a number of the first Bi-based particles 14a is 0.5 to 6.0 times the number of the third Bi-based particles 14c. Since the aspect ratio Z of the third Bi-based particles 14c is greater than that of the second Bi-based particles 14b, the third Bi-based particles 14c have more elongated shape than the second Bi-based particles 14b. Also, the third Bi-based particles 14c effect similarly as the second Bi-based particles 14b. In particular, since the third Bi-based particles 14c have a more elongated shape than the second Bi-based particles 14b, the third Bi-based particles 14c are not liable to be deformed all the more compared to the second Bi-based particles 14b. Thus, a sliding member obtains excellent fatigue resistance and seizure resistance by having all of the first Bi-based particle 14a satisfying Z<2, the second Bi-based particles 14b satisfying 2≦Z<3, and third Bi-based particles 14c satisfying 3≦Z, and satisfying all of a≧30%, 0.5≦d≦6.0, and 0.5≦e≦6.0.

In the embodiment shown in FIG. 1, as described above, the invention can be applied to a sliding member 11 provided with an overlay layer 13 on a base 12 having a back metal layer 12a, a bearing alloy layer 12b on the back metal layer 12a, and an intermediate layer 12a on the bearing alloy layer 12b. It is possible to obtain bearing properties of the bearing alloy layer 12b since the bearing alloy layer 12b is included in the base 12. Furthermore, since the intermediate layer 12c as a bonding layer is provided between the bearing alloy layer 12b and the overlay layer 13, it is possible to prevent the overlay layer 13 from peeling off from the base 12 as much as possible. The intermediate layer 13c, which contains any one of Ni, a Ni alloy, Ag, a Ag alloy, Co, a Co alloy, Cu and a Cu alloy, can bond strongly to the bearing alloy layer 12b and the overlay layer 13. This can effectively prevent the overlay layer 13 from peeling off from the base 12.

In a case where an overlay layer 13 containing the Bi-based particles 14 composed of Bi or a Bi alloy is formed on a base 12 by Bi electroplating, the inventors found out that a shape of the Bi-based particles 14 in the overlay layer 13 can be varied by conducting the Bi electroplating while producing minute coarseness and fineness of current density on the surface of the base 12. That is, the inventors found out that micronanobubbles, which are minute bubbles, are supplied on the surface of the base 12 during conducting the Bi electroplating for forming the overlay layer 13 on the base 12, and minute coarseness and fineness of current density are produced on the surface of the base 12, whereby it is possible to make the first Bi-based particles 14a, the second Bi-based particles 14b, and the third Bi-based particles 14c be distributed in the overlay layer 13.

### Examples

In general, a sliding bearing, which is a sliding member, is obtained as follows. A bearing alloy layer made of a Cu alloy or an Al alloy is provided on a back metal layer made of steel, and an intermediate layer is provided, as required, on the bearing alloy layer to constitute a base. On the base, an overlay layer is formed.

The sliding member (sliding bearing) of the invention is obtained as follows. In order to confirm effects of the sliding member (sliding bearing) of the invention, samples (examples of the invention 1 to 7 and comparative examples 1 to 5) shown in Table 1 were obtained.

TABLE 1

| | | | Rate of aspect ratio | | Bearing properties | |
|---|---|---|---|---|---|---|
| Sample No. | | Aspect ratio a b c | $d ( = \frac{a}{b} )$ | $e ( = \frac{a}{c} )$ | Maximum specific load with no fatigue | Maximum specific load with no seizure |
| Example | 1 | 39 37 24 | 1.1 | 1.6 | 100 | 100 |
| of the | 2 | 45 42 13 | 1.1 | 3.5 | 100 | 100 |
| invention | 3 | 55 10 35 | 5.5 | 1.6 | 95 | 100 |
| | 4 | 56 31 13 | 1.8 | 4.3 | 95 | 100 |
| | 5 | 32 33 35 | 1.0 | 0.9 | 100 | 95 |
| | 6 | 30 25 45 | 1.2 | 0.7 | 100 | 95 |
| | 7 | 70 17 13 | 4.1 | 5.4 | 90 | 100 |
| Compara- | 1 | 0 30 70 | 0.0 | 0.0 | 85 | 55 |
| tive | 2 | 20 50 30 | 0.4 | 0.7 | 85 | 65 |
| example | 3 | 80 9 11 | 8.9 | 7.3 | 50 | 80 |
| | 4 | 50 5 45 | 10.0 | 1.1 | 60 | 80 |
| | 5 | 55 38 7 | 1.4 | 7.9 | 60 | 80 |

First, a bimetal was fabricated by lining a bearing alloy layer of a Cu alloy on a steel back metal and then the bimetal was formed into a semicylindrical or cylindrical shape to obtain a piece. Next, a surface of the bearing alloy layer of the piece was finished by boring and the surface was cleaned by electrolytic degreasing and acid treatment. Next, an intermediate layer was formed on a surface of the piece if required, and an overlay layer was formed by Bi electroplating on the piece (or an intermediate layer when the intermediate layer is formed in the formed piece). The Bi electroplating was conducted under conditions shown in Table 2.

For Examples of the invention 1 to 7, micronanobubbles were generated in a plating solution with use of a micronanobubble generator (illustration omitted) during the Bi electroplating, and the micronanobubbles were supplied on the surface of the piece (the intermediate layer).

TABLE 2

| | | | |
|---|---|---|---|
| Plating solution composition | Bi concentration | 20-70 | g/litter |
| | Sn concentration | 0-10 | g/litter |
| | Cu concentration | 0-10 | g/litter |
| | Organic sulfonic acid | 30-90 | g/litter |
| | Additives | 5-70 | g/litter |

| | | |
|---|---|---|
| Current density | 3-8 | A/dm² |
| Plating bath temperature | 35-60° | C. |

| | |
|---|---|
| Means for generating minute coarseness and | micronanobubble |
| fineness of current density | generator is used |

Minute coarseness and fineness of current density were generated on the surface of the piece (the intermediate layer) by supplying the micronanobubbles on the surface of the piece (the intermediate layer), and thus first Bi-based particles, second Bi-based particles and third Bi-based particles were precipitated. As a device for generating micronanobubbles, used was a type of device which shears a plating solution and air under high pressure in a spiral flow pass. In the flow path, the plating solution is circulated in an order of a plating tank, a pump, a filter and the plating tank. The device for generating micronanobubbles was positioned in the flow path between the filter and the plating tank.

A diameter of the micronanobubbles in the plating solution was measured using Shimadzu nanoparticle diameter distribution device “SALD-7100.” As a result of the measurement, not less than 80% of a number of all bubbles in the Bi plating solution used in the fabrication of Examples 1 to 7 of the invention had a diameter of 500 to 1000 nm.

Examples 1 to 7 of the invention were obtained by the above-described fabrication method.

Comparative Examples 1 to 5 were obtained by the same fabrication method as Examples 1 to 7 of the invention, with exception that minute coarseness and fineness of current density were not generated.

The difference between values of “a”, “b” and “c” of the “aspect ratio” in Table 1 are generated due to effect of minute coarseness and fineness of current density generated by supplying bubbles.

Column “a” of the “aspect ratio” in Table 1 expresses, by percentage, a ratio of a number of the first Bi-based particles in relation to a total number of Bi-based particles. Similarly, column “b” of the “aspect ratio” in Table 1 expresses, by percentage, a ratio of a number of the second Bi-based particles in relation to the total number of Bi-based particles, and column “c” of the “aspect ratio” in Table 1 expresses, by percentage, a ratio of a number of the third Bi-based particles to the total number of Bi-based particles. In the column “rate of aspect ratio” in Table 1, “d” expresses a value of “a/b” and “e” expresses a value of “a/c”.

A cross section of the overlay layer 13 was observed with a scanning ion microscope. An observational field of view is 5 μm×5 μm, and a measurement magnification is 25,000 times. A major axis X and a minor axis Y were measured for all of the Bi-based particles included in the observational field of view. Aspect ratio Z was obtained by dividing the major axis X by the minor axis Y, and on the basis of the aspect ratio Z the observed Bi-based particles were classified into any one of the first Bi-based particles, the second Bi-based particles, and the third Bi-based particles to obtain values of “a,” “b,” “c,” “d,” and “e” in Table 1.

For each of the above-described samples, a fatigue resistance test was conducted under conditions shown in Table 3 below and a seizure test was conducted under conditions shown in Table 4. Results are shown in Table 1.

TABLE 3

| Inner diameter of bearing | 60 | mm |
|---|---|---|
| Bearing width | 20 | mm |
| Revolutions | 3000 | rpm |
| Lubricant | VG22 | |
| Shaft material | JIS S55C | |
| Test duration | 12 | hours |

| | |
|---|---|
| Evaluation method | Maximum specific |
| | load with no cracks |

TABLE 4

| Inner diameter of bearing | 50 | mm |
|---|---|---|
| Bearing width | 18 | mm |
| Velocity | 15 | m/second |
| Lubricant | VG22 | |
| Oil flow | 100 | ml/minute |
| Test load | 5 | MPa increased at |
| | | 10-minute interval |

| | |
|---|---|
| Evaluation method | Seizure is judged when bearing |
| | outer surface temperature rises |
| | over 200° C. or test |
| | shaft drive belt slips |

The results of the fatigue resistance test and seizure test are analyzed.

From a comparison between Examples 1 to 7 of the invention and Comparative Examples 1 to 5, it can be understood that Examples 1 to 7 of the invention are superior in both fatigue resistance and seizure resistance to Comparative Examples 1 to 5 since Examples 1 to 7 of the present invention satisfy all of a≧30 (%), 0.5≦d≦6.0, and 0.5≦e≦6.0.

From a comparison between Examples 1 and 2 of the invention and Examples 3 to 7 of the invention, it can be understood that Examples 1 and 2 are superior in both fatigue resistance and seizure resistance to Examples 3 to 7 since Examples 1 and 2 satisfy all of 35≦a≦70, 0.8≦d≦4.0, and 0.8≦e≦4.0.

In the examples of the present invention which includes an intermediate layer between a bearing alloy layer and an overlay layer, in particular, the intermediate layer made of any one of Ag, a Ag alloy, Co, a Co alloy, Cu and a Cu alloy, the overlay layer after the test did not peel off from the base even when the test was conducted under severe conditions.

### INDUSTRIAL APPLICABILITY

A typical example of a sliding member is a sliding bearing used in an internal-combustion engine of an automobile and the like.

### LIST OF REFERENCE NUMERALS

In the drawings, 11 denotes a sliding member, 12 denotes a base, 12a denotes a back metal layer (base), 12b denotes a bearing alloy layer (base), 12c denotes an intermediate layer (base), 13 denotes an overlay layer, and 14 denotes a Bi-based particle.

1. A sliding member comprising:
a base; and
an overlay layer on the base, the overlay layer including Bi-based particles consisting of Bi or a Bi alloy, the Bi-based particles having a major axis and a minor axis orthogonal to the major axis at a midpoint of the major axis,
wherein when a length of the major axis is expressed by X, and a length of the minor axis is expressed by Y, and an aspect ratio Z is defined by X/Y, the Bi-based particles are classified into first Bi-based particles satisfying Z<2, second Bi-based particles satisfying 2≦Z<3, and third Bi-based particles satisfying 3≦Z, and
wherein when a ratio of a number of the first Bi-based particles in relation to a total number of the Bi-based particles is expressed by a%, a ratio of a number of the second Bi-based particles is expressed by b%, a ratio of a number of the third Bi-based particles is expressed by c%, a/b is defined as d, and a/c is defined as e,
a≧30,
0.5≦d≦6.0, and
0.5≦e≦6.0
are satisfied.

2. The sliding member according to claim 1, wherein 35≦a≦70, 0.8≦d≦4.0, and 0.8≦e≦4.0 are satisfied.

3. The sliding member according to claim 1, wherein the base comprises a back metal layer, a bearing alloy layer on the back metal layer, and an intermediate layer on the bearing alloy layer, and
wherein the intermediate layer comprises at least one layer composed of a material selected from a group consisting of Ni, a Ni alloy, Ag, a Ag alloy, Co, a Co alloy, Cu and a Cu alloy.

4. The sliding member according to claim 2, wherein the base comprises a back metal layer, a bearing alloy layer on the back metal layer, and an intermediate layer on the bearing alloy layer, and
wherein the intermediate layer comprises at least one layer composed of a material selected from a group consisting of Ni, a Ni alloy, Ag, a Ag alloy, Co, a Co alloy, Cu and a Cu alloy.

5. The sliding member according to claim 3, wherein the bearing alloy layer comprises an Al-based bearing alloy.

6. The sliding member according to claim 3, wherein the bearing alloy layer comprises a Cu-based bearing alloy.
